(19) United States
(12) Patent Application Publication
(10) Pub. No.: US 2015/0290085 A1
(43) Pub. Date: Oct. 15, 2015

(54) MEDICATION CONTAINER

(71) Applicant: PROTOMED LIMITED, Congleton (GB)

(72) Inventor: Norman Niven, Cheadle (GB)

(21) Appl. No.: 14/443,092

(22) PCT Filed: Nov. 18, 2013
(86) PCT No.: PCT/GB2013/053035

§ 371 Date: May 15, 2015

(30) Foreign Application Priority Data
Nov. 16, 2012 (GB) 1220632.2

(51) Int. Cl. A61J 7/04

(52) U.S. Cl. CPC A61J 7/04; A61J 2200/30; A61J 7/0436

(57) ABSTRACT

The present invention relates to medication containers configured to detect and/or monitor dispensation of a medicament from the medication container. Each medication container comprises a medication tray comprising a plurality of sealed vessels, each containing a medicament; a cover member covering the sealed vessels and adapted to permit dispensing of individual medicaments and/or vessels therethrough; wherein the cover member is associated with an electrical detection means configured to automatically produce an electrical response to a medicament and/or vessel being dispensed through the cover member.

### INTRODUCTION

The present invention relates to medication containers. More specifically, the present invention relates to medication containers configured to detect and/or monitor dispensation of a medicament from the medication container.

### BACKGROUND

In recent years, individual patient medication dispensing systems, such as the monitored dosing systems disclosed in WO 2009/047560, have become widely used in environments such as elderly care homes. Such monitored dosing systems allow carers to dispense individual pots of medication to care home residents in a convenient, safe, readily administrable and, importantly, a monitored fashion. Furthermore, such monitored dosing systems are medication containers that can accommodate individual doses of medicament in either solid dosage forms (including, for example, tablets, capsules, pessaries, creams and ointments) or in liquid dosage form (including, for example, solutions, suspensions and emulsions).

The medication containers of WO 2009/047560 allow medicament dispensation to be monitored via visual inspection—i.e. a carer and/or patient knows a medication, corresponding to a particular time and date, has been dispensed by merely observing a vacancy in the medication container. The vacant compartment, being typically labelled with an appropriate time and date, is therefore indicative of the medication having been dispensed. Despite the numerous advantages associated with the monitored dosing systems described in WO 2009/047560, and the improved patient compliance that they offer, there remains a need to further enhance patient compliance and/or enable an individual patients' therapy to be monitored more closely.

The medication containers of WO 2011/064600 address this need by providing an additional electronic detection means, within a base sheet affixed to the bottom of the medication containers, adapted to automatically detect and monitor when individual vessels are dispensed from the compartments of the tray. In such cases, a vessel is dispensed by strategically applying an upward force to the base of the medication container to first puncture a pre-defined potion of the base sheet and subsequently push the vessel upwardly out of the medication container (e.g. a person's thumb or finger may puncture the base sheet as an upward force is applied). Sensors within said base sheet then detect such puncturing via the built-in sensors. This detection system takes advantage of the initial force applied to dispense the vessel. Furthermore, in the same document, portable medicament carriers are disclosed which allow a patient to take, from a primary (less portable) medication container, a number of individual sealed vessels and carry them in a temporary storage carrier which again electronically records the dispensing of medicines. However, since these portable models are not particularly compatible with the sensory base sheets of the non-portable models, WO 2011/064600 does not apply the automatic detection technology to the portable models. Instead, manual input of information via a user interface is required to electronically monitor medicament dispensation. As a consequence of this extra burden, certain dispensation recordals may be missed or entered late, thereby potentially leading to the inaccurate recordal of a patient's medicament consumption.

It is therefore an object of the present invention to provide a means to adapt portable medication containers to automatically monitor medicament dispensation. It is a further object of the invention to improve the accuracy and reliability of electronic monitoring of medicament dispensation. It is also an object of the present invention to provide an alternative means to automatically monitor medicament dispensation.

### SUMMARY OF THE INVENTION

According to a first aspect of the present invention, there is provided a medication container, comprising:

a medication tray comprising a plurality of sealed vessels, each containing a medicament;

a cover member covering the sealed vessels and adapted to permit dispensing of individual medicaments and/or vessels therethrough,

wherein the cover member is associated with an electrical detection means configured to automatically produce an electrical response to a medicament and/or vessel being dispensed through the cover member.

According to a second aspect of the present invention, there is provided a medication container comprising:

a medication tray configured for receiving a plurality of medicament-containing sealed vessels; and

a cover member for covering the sealed vessels and adapted to permit dispensing of individual medicaments and/or vessels therethrough,

wherein the cover member is associated with an electrical detection means configured to automatically produce an electrical response to a medicament and/or vessel being dispensed through the cover member.

According to a third aspect of the present invention, there is provided a cover member for covering a plurality of medicament-containing sealed vessels of a medication tray, the cover member being adapted to permit dispensing of medicaments and/or vessels therethrough, and associated with an electrical detection means capable of automatically producing an electrical response to a medicament and/or vessel being dispensed through the cover member.

According to a fourth aspect of the present invention, there is provided a method of producing a medication container (e.g. of the first aspect), the method comprising:

associating the cover member, as defined herein, with a medication tray, as defined herein;

configuring the cover member relative to the medication tray such that the cover member permits dispensing of medicaments and/or vessels therethrough.

According to a fifth aspect of the present invention, there is provided a kit of parts comprising a medication tray (or carrier tray) configured for receiving a plurality of sealed vessels, and the cover member as defined herein.

According to a sixth aspect of the present invention, there is provided a method of dispensing medication, the method comprising:

providing a medication container, as defined herein;

removing a medicament and/or a medicament-containing vessel from the medication container, out through the cover member to thereby automatically trigger an electrical response in the electrical detection means.

According to a seventh aspect of the present invention, there is provided a use of a cover member, as defined herein, for monitoring the dispensation of a medicament and/or a medicament-containing vessel.

According to a eighth aspect of the present invention, there is provided a blank for manufacturing a medication container, the blank comprising:

a carrier tray configured for receiving a plurality of sealed vessels;

a cover member, as defined herein, connected to the carrier tray at a first fold line;

wherein the cover member is foldable about the first fold line to cover the carrier tray so as to permit the dispensing of medicaments and/or vessels from the carrier tray through the cover member.

Features, including optional, suitable, and preferred features of any aspect of the present invention are, unless stated otherwise, also features, including optional, suitable, and preferred features of any other aspect of the present invention.

The electrical response triggered by dispensing a medicament and/or vessel may be used to detect and/or monitor such dispensation. The electrical detection means enables data relating to the dispensing of the medicament and/or a medicament-containing vessel to be collected, recorded and analysed. This enables the compliance of the patient with a particular therapeutic regime to be monitored and recorded.

An advantage of the medication containers of the present invention is that they can be adapted for portability without losing the advantages of automatic dispensation monitoring. Furthermore, the invention provides an alternative means to automatically monitor medicament dispensation, by providing the electrical detection means in association with the cover through which the medication/vessels must pass. Such an arrangement renders the act of medication/vessel dispensation inseparable from the electrical detection thereof, which significantly improves the credibility and accuracy of the monitoring data thereby produced. This arrangement is also simple, in terms of manufacturing, easily customisable, universally applicable to various sizes and types of medication container, cheap, and easy to use. Furthermore, since the cover is separate from the seals of the sealed vessels, the cover member can be added, if desired, at the point of dispensing the medication, whether in the pharmacy or by carers in a care home. As such, the present invention offers a choice on whether or not to add a cover member to a prefabricated medication tray (i.e. to retrofit the cover member). Such a choice allows cost savings to be made where monitored dosing is not required.

The particular arrangement, according to the present invention, whereby medicaments and/or sealed vessels are removed from a medication tray through a cover to trigger an electric response within the cover itself, is unique in terms of its effectiveness, convenience, flexibility, scope of application, and reliability. The arrangement also improves the practical viability of portable monitored dosing medication containers, since medicament dispensation may now be automatically monitored (rather than relying on manual input of dispensation information), and furthermore such portable containers may potentially be reused by simply replacing a “used” cover member. This in turn allows care homes, and the like, to more effectively monitor patient compliance at a distance, thereby providing patients with more personal freedom.

### BRIEF DESCRIPTION OF THE DRAWINGS

For a better understanding of the present invention, and to show how embodiments of the same may be put into effect, reference is now made, by way of example, to the following diagrammatic drawings, in which:

FIG. 1 is top perspective view of an embodiment of a medication container in a partially unfolded configuration;

FIG. 2 is a top view of a “blank” of the medication container of FIG. 1 (without vessels);

FIG. 3 is a top view of the “blank” of FIG. 2, showing electrical circuitry present within the medication container; and

FIG. 4 is a top perspective view of the medication container of FIG. 1, showing the removal of a sealed vessel.

### DETAILED DESCRIPTION OF THE INVENTION

### Medication Containers

According to a first aspect of the present invention, there is provided a medication container, comprising:

a medication tray comprising a plurality of sealed vessels, each containing a medicament;

a cover member covering the sealed vessels and adapted to permit dispensing of individual medicaments and/or vessels therethrough,

wherein the cover member is associated with an electrical detection means configured to automatically produce an electrical response to a medicament and/or vessel being dispensed through the cover member.

According to a second aspect of the present invention, there is provided a medication container comprising:

a medication tray configured for receiving a plurality of medicament-containing sealed vessels; and

a cover member for covering the sealed vessels and adapted to permit dispensing of individual medicaments and/or vessels therethrough,

wherein the cover member is associated with an electrical detection means configured to automatically produce an electrical response to a medicament and/or vessel being dispensed through the cover member.

The “medication container” suitably complies with the relevant standards, whether regulatory or otherwise, for the containment and storage of medication. As such, any medical substance stored therein should be substantially protected from decomposition and/or contamination, and thus the medication container should be suitably clean, sealable, of an appropriately size, and accessible by the user.

In a particular embodiment, the medication container is a portable medication container, suitably comprising sealed vessels previously dispensed from another separate medication container.

In some embodiments, the medication container additionally comprises a lid, which may be arranged to close over the cover member upon the medication tray. In some embodiments, such a lid may comprise part of the electrical detection means.

In some embodiments, the medication tray and cover member are integrally formed (i.e. from a single continuous piece of material). In some embodiments, the cover member and an additional lid are integrally formed. In some embodiments, the medication container comprises a medication tray, a cover member, and a lid, all of which may be integrally formed.

### Medicament

The medicament suitably comprises one or more solid or liquid medical substances. The medicament may comprise a single solid or liquid medical substance. In an embodiment, the medicament may comprise more than one type of medical substance, typically where only solid medical substances are present (e.g. multiple tablets). In a particular embodiment the medical substance is a liquid substance, which may be suitably administered (e.g. orally consumed) directly from the vessel. In another embodiment the medical substance is a solid, suitably a tablet or capsule. Suitably the medical substance is for oral administration.

### Medication Tray

The medication tray may be any medication tray suitable for carrying medication. The medication tray is general selected from unit dose packaging containers, blister packs, and monitored dosing system containers.

The medication tray suitably comprises a carrier tray configured for receiving a plurality of sealed vessels. The medication tray may further comprise a plurality of sealed vessels within the carrier tray. As such, the carrier tray is suitably the medication tray without the sealed vessels.

In the context of the present invention, the medication tray may or may not comprise the plurality of sealed vessels, depending on the aspect in question. In the context of a kit of parts, the medication tray may be described as being “configured for receiving a plurality of sealed vessels” (i.e. as per a carrier tray), meaning that the vessels are absent.

Suitably, the medication tray comprises a platform or carrier tray, which suitably comprises compartments (or apertures) for receiving the vessels. In a particular embodiment, the medication tray comprises:
a carrier tray having a plurality of individual spaced compartments (or apertures);
a plurality of medicament-containing sealed vessels individually removably received within the respective compartments (or apertures).

In an embodiment, the medication tray may comprise its own retaining means to retain the vessels within the medication tray—e.g. a cover or sealing sheet which holds the vessels in place within the medication tray. In the context of the medication tray of the invention, a “retaining means” refers herein to a means of holding vessels such that they do not fall out from the medication tray, regardless of the orientation in which the medication tray is held.

In alternative embodiments, the vessels are not retained within the medication tray by a retaining means, but are instead retained within the medication tray by the cover member of the present invention.

The vessels are suitably removable from the tray by applying a force to the respective vessel. The vessels are suitably removable from the tray through applying an upwards force to the bottom of the respective vessel to push the vessel out through the cover member. In an embodiment (e.g. portable containers), vessels are removed by applying a force directly to the base of the vessels, i.e. rather than applying a force indirectly via the base of a deformable compartment of the tray.

In an embodiment, the compartments of the medication tray comprise deformable sides and/or a deformable base so as to enable pressure to be applied to the compartment, e.g. to the base of the compartment, in order to cause the vessel to be dislodged from the compartment.

The medication tray may comprise any number of vessels. Suitably the tray comprises at least two, or at least four, or at least eight vessels. Suitably the tray comprises at most 50 vessels, more suitably at most 40 vessels, even more suitably at most 30. In an embodiment, the tray comprises 28 vessels. However, the tray may be provided as a large continuous tray comprising numerous vessels and one or more predefined break points at which individual smaller trays may be detached from the large continuous tray. The one or more break points may be weaker points in the structure of the tray (in a similar manner to the release portions defined herein) such as, for example, perforations or scorings. The break points may differ from the release portions in one or more aspects, for example, breakability (i.e. the break points may be weaker and hence easier to break than the release portions).

Suitably the tray comprises two or more rows of vessels wherein each row comprises two or more vessels, suitably arranged side-by-side. In a particular embodiment, the tray comprises seven rows of vessels, thereby providing a row corresponding to each day of the week. The vessels along any particular row may contain medical substances for consumption at different times in a given day. Alternatively, each vessel along a row may contain a different medical substance. In an embodiment, the tray comprises four vessels per row.

The tray may be portable. In a particular embodiment, the medication container is a temporary storage container in which medicament-containing sealed vessels can be carried away from a source from which they were dispensed (e.g. a principle medication container of greater size than the temporary storage container). In such embodiments, the temporary storage container comprises at most 8 sealed vessels, suitably at most 4 sealed vessels. The vessels are suitably arranged to minimise the largest dimension, to facilitate portability.

In an embodiment, the sealed vessels are completely separate from each, i.e. not linked together directly or indirectly (e.g. via a common sealing means).

The medication tray may comprise or be formed of any suitable material known in the art. In particular embodiments, the medication tray is formed of cardboard or moulded plastics material.

In an embodiment, the medication tray is substantially non-portable (i.e. not designed to be carried around by the patient). In an embodiment, the medication tray is a medication tray/container such as that described and defined in WO 2009/047560, the entire contents of which are incorporated herein by reference. As such, the medication tray may comprise:

a tray having individual spaced compartments, a plurality of medicament-containing sealed vessels individually removably received within the respective compartments, means releasably to retain the vessels in the compartments prior to intended release, and means sealingly to retain the medicament in the vessels prior to their intended use.

In line with the arrangement of the invention, the cover member suitably fits on top of this medication tray, suitably against the means releasably to retain the vessels in the compartments (which may well serve the dual function of sealingly retaining the medicament within the vessels).

Suitably, the sealed vessels of the present invention correspond with the vessels (or pots) as defined in WO 2009/047560. Suitably, the medication tray comprises a sealing arrangement as defined in WO 2009/125364, the entire contents of which are incorporated herein by reference. The tray may be formed using a sealing apparatus such as that described in WO 2010/001152, the entire contents of which are incorporated herein by reference. In a particular example, the medication tray comprises:

individual spaced compartments,

a plurality of pots individually removably received within the respective compartments, wherein each pot has an upper flange and is adapted to contain a medication to be packaged,

means to releasably retain the pots in the compartments prior to intended release, and

means to sealingly retain the medication in the pots prior to its intended use;

wherein the means to sealingly retain the medication in the pots comprises a flexible perforated sheet of non-permeable material placed over the filled tray and sealingly attached to and across an otherwise open top of each pot, and wherein the perforations coincide with the outer peripheries of the pots so as to define individual sealed films across each pot, and once the pot is removed the sealed film can be peeled off the upper flange to open the pot.

In an embodiment, each compartment may have an aperture in a base region thereof to enable a sealed vessel releasably retained therein to be pushed out of its compartment.

In another embodiment, the medication tray is as defined in co-pending International Application PCT/GB2012/050682, the entire contents of which are incorporated herein by reference. The medication tray in this embodiment comprises:
a plurality of individually spaced vessels, each vessel being adapted to contain one or more doses of a medical substance; and

sealing means to seal and releasably retain the medical substance within the vessels;

characterised in that the vessels are integrally formed with the tray; and each vessel can be selectively detached from the tray at a predefined release portion.

In line with the arrangement of the invention, the cover member suitably fits on top of this medication tray, suitably against the sealing means. In a particular embodiment, the medication tray comprises:

a plurality of individually spaced vessels, each vessel being adapted to contain one or more doses of a solid or liquid medical substance; and

sealing means to seal and releasably retain the medical substance within the vessels; wherein:

the sealing means is a seal which is impermeable to any liquid medical substance;

the vessels are flanged pots integrally formed with the tray such that the pots are conjoined together by an upper platform which extends across the top surface of the tray; and each individual pot can be selectively detached from the tray at a predefined release portion, leaving any remaining pots attached to the tray;

each pot has its own specific release portion, not shared by any adjacent pots; and wherein a predefined release portion comprises a pre-weakened portion of the upper platform which allows a flanged pot to be readily removed through applying an upwards force to the bottom of the respective pot;

the pots are adapted to contain a solid or liquid medical substance which can be consumed directly from a released pot via oral administration.

In an embodiment, the medication tray is portable (i.e. designed to be carried around by the patient, e.g. in a carrier bag). The medication tray may be a medication tray/container such as that described and defined in WO 2009/150453, the entire contents of which are duly incorporated by reference. The medication tray in this embodiment comprises:

a carrier tray defining a plurality of apertures each configured to receive one of a plurality of individual sealed vessels, each vessel of complementary lateral dimensions with a peripheral flange adapted to rest upon the carrier tray around one of said apertures with the body of the vessel extending beneath the carrier tray.

In such embodiments, the base of the vessels are exposed, preferably completely exposed (i.e. without being partially covered by the walls or base of a tray compartment), and said vessels are suitably removed by upwardly pushing directly upon the exposed base of the vessels.

In line with the arrangement of the invention, the cover member suitably fits on top of this medication tray, suitably against the top (i.e. flange end) of the sealed vessels.

The carrier tray may define four such apertures arranged in a single row thus to carry four such vessels side-by-side. The carrier tray may define four such apertures arranged in pairs thus to carry four such vessels in two side-by-side pairs.

The cover member may be integrated into the medication tray, i.e. integrally formed with the carrier tray. For instance, the carrier tray and cover member may be made as a single piece from moulded plastics. The carrier tray and cover member may be made as a single piece from paperboard.

The medication tray may further comprise a lid. The lid is suitably integrally formed (i.e. of one piece) with the carrier tray. The lid may be operated to open and close the carrier tray. In the closed position, the lid suitably covers the cover member. In a particular embodiment, the lid, carrier tray, and cover member are all integrally formed (i.e. of one piece).

In a particular embodiment, the medication tray has a substantially flat platform with a series of holes therein complementary in size and shape to the individual sealed flanged pots which sit within said holes with their flanges resting upon the platform around the respective holes. Each pot has a seal in the form of a lid. In such embodiments, the cover member is positioned over the vessel lids, such that it retains the pots within their respective holes. When in place upon the medication tray, the cover member has a series of strategically positioned doors overlying each flanged pot, such that the door can be opened to allow the flanged pot to be dispensed. Suitably each door remains closed until a flange pot is forced upwards through the door, at which point the door is opened to thereby trigger a detectable electrical response.

In another embodiment, the medication tray is a standard blister pack (e.g. “Push-Through-Pack (PTP)”). Standard blister packs generally comprise a series of blister cavities (typically formed within a single sheet) filled with medicament and sealed with a sealing film. Typically a single sealing film extends across the openings of all the cavities. Blister packs are typically generated by a form-fill-seal process from rolls of flat sheet or film, filled with the medicament and sealingly closed on the same machine. The blister cavities represent a plurality of vessels in the context of the invention. The cover member of the present invention may then be fitted (or retrofitted) to the blister pack, suitably against the sealing film. Individual medicaments can then be removed from each blister, and out through the cover member to thereby automatically trigger a detectable electrical response. This embodiment demonstrates the universal applicability of the present invention, since the technology can be used to monitor dispensation/consumption of medication even from standard commercial medication packs (e.g. such as that which can be purchased in retail outlets and pharmacies).

### Sealed Vessels

The sealed vessels may comprise any vessel suitable for holding, storing, and/or transporting medicaments. In particular, the sealed vessels suitably comply with the relevant standards, whether regulatory or otherwise, for the containment and storage of medication. As such, the sealed vessels suitably protect the medicament contained therein from decomposition and/or contamination, and thus the vessels must be suitably clean, sealable, of an appropriately size, and accessible by the user. The sealed vessels are suitable sealed with a sealing means (i.e. a seal). The seal provides for the safe containment and storage of medication in accordance with the aforesaid relevant standards. As such, vessels must be typically be sealed in a substantially air-tight manner.

The vessels may comprise or be formed of any suitable material known in the art. In a particular embodiment, the vessels are formed of moulded plastics material.

Each vessel suitably comprises a seal that is separate to the vessel itself, such as a sealing film or sealing lid.

In an embodiment, the vessels are individual pots (e.g. small cup-shaped vessels).

The pots are suitably flanged pots (i.e. having a flange around the rim of the pots). The pots may be suitably adapted to contain a solid or liquid medical substance which can be consumed directly from a released pot via oral administration.

The pots may be integrally formed with the medication tray, for instance, as described in co-pending International Application PCT/GB2012/050682. As such, the pots may be detachably linked to the medication tray, for instance by spokes, tags, or along perforations, whereby the link may be broken to remove the pots.

The pots may suitably be separate from the tray (i.e. not integrally formed therewith), for instance, as described in WO 2009/047560 or in WO 2009/150453 (portable tray). As such, the pots may be releasably retained within the tray by an additional retaining means, such as a flexible sealing sheet, which optionally serves the dual function of retaining the vessels within the tray and also sealing the medicament within the vessels. The pots may, on the other hand, be retained by the cover member.

The sealed vessels may be completely separate from each other, i.e. not linked directly or indirectly (e.g. via a common sealing sheet).

The vessels and any compartments (or apertures) of the tray are suitably of complementary shape and size, such that the vessels can be received within the compartments (or apertures). The depth of each vessel is suitably greater than or equal to 0.5 cm, suitably greater than or equal to 1 cm, suitably greater than or equal to 2 cm. Suitably each vessel has a depth less than or equal to 5 cm, suitably less than or equal to 4 cm, suitably less than or equal to 3 cm. The area defined by the mouth of each vessel is suitably greater than or equal to 0.5 cm², suitably greater than or equal to 1 cm², suitably greater than or equal to 2 cm². The area defined by the mouth of each vessel is suitably less than or equal to 9 cm², suitably less than or equal to 5 cm², suitably less than or equal to 3 cm². The volume capacity of each vessel is suitably greater than or equal to 0.25 cm³, suitably greater than or equal to 1 cm³, suitably greater than or equal to 2 cm³, suitably greater than or equal to 5 cm³. The volume capacity of each vessel is suitably less than or equal to 45 cm³, suitably less than or equal to 20 cm³, suitably less than or equal to 10 cm³.

Each sealed vessel suitably comprises its own individual seal. However, the plurality of individual seals may be connected (e.g. as a single sheet covering all the vessels), whether or not the vessels are themselves connected (e.g. via the tray). In such cases, the individual seals are suitably separable, for instance, by virtue of perforations allowing individual seals to be separated.

In a particular embodiment, both the vessels and their respective seals are separate from one another. Such sealed vessels are particularly appropriate in portable medication containers, where individual sealed vessels may be taken from a primary medication container (larger than the portable medication container) and placed into the portable medication container for carriage away from the primary medication container for later use.

Each sealed vessel suitably comprises a sealing means, across the opening of each vessel, configured to releasably retain the medicament in the vessel. The sealing means can be removed and/or broken in order to access the medicament present in the vessel.

The sealing means which releasably retains the medicament in the vessels may suitably take the form of a sheet of material (suitably flexible material) that covers the opening of the vessel and forms a sealed contact around the vessel opening.

The sheet of material may optionally display printed matter that identifies the medicament present in the vessel. The sheet of material may display printed matter identifying the medicament present in the vessel and the purpose for, or manner in which, the medicament is to be used.

The sheet of material forming the sealed closure or sealing means may comprise a portion or outer edge which is not directly adhered to the vessel and which can be held and used to peel the sheet of material away from the opening of the vessel, thereby breaking the seal and enabling the medicament present in the vessel to be accessed.

In some embodiments, a peripheral flange may be provided around the top of each vessel, a part of which is readily deformable to assist in peeling off the sheet of material to open the vessel.

Suitably the sheet of material forming the sealing means is a plastic sheet, in particular a transparent plastic sheet. The transparency enables the content of each vessel to visualised.

In a particular embodiment, the vessels are cavities or compartments formed in a single continuous sheet. For example, the vessels may suitably be the cavities of a blister pack, where such cavities comprise an opening sealed by a sealing means. Suitably the cavities are sealed by a sealing means, wherein the sealing means is suitably a single sealing sheet which extends across the openings of all the cavities to seal the medicament container within said cavities. The cavities are suitably deformable, and the sealing means suitably breakable, to allow the medicament contained within the cavities to be “pushed out” through the sealing means by applying an upward force to the underside of the cavities. In such embodiments, the cover member suitably overlies the sealing means such that medicament passes through the cover member as the medicament is “pushed out” of the a respective cavity.

### Cover Member

According to a further aspect of the present invention, there is provided a cover member for covering a plurality of medicament-containing sealed vessels of a medication tray, the cover member being adapted to permit dispensing of medicaments and/or vessels therethrough, and associated with an electrical detection means capable of automatically producing an electrical response to a medicament and/or vessel being dispensed through the cover member.

The cover may include the electrical detection means or may include part of the electrical detection means (i.e. such that part of the electrical detection means is elsewhere, e.g. in another portion of the medication container, for example a lid). The cover member is suitably connected to the electrical detection means.

The cover member is separate and distinct from any sealing means used to seal the sealed vessels. The cover member suitably serves no sealing function. Keeping the cover member, and therefore the detection means, separate from the vessel seals advantageously reduces any electrical interference with the medicament itself, which is potentially a significant problem for liquid medications which may be electrolysed when exposed to anodic and cathodic potentials.

The cover member is suitably associated with the medication tray so as to cover the sealed vessels whilst also permitting removal of said sealed vessels through the cover. Suitably the medication container is configured such that the only practical way to remove the sealed vessels therefrom is through the cover member.

The cover member primarily serves as a detector, to detect removal of a sealed vessel and/or a medicament from the medication tray. Due to the configuration of the medication containers of the invention, it is difficult to accidently trigger an electrical response, since a sealed vessel must in general be physically moved through the cover member before a response is triggered. This is in contrast to the prior art, where accidental puncturing of a base member may lead to false recordals. The cover member suitably detects and identifies which particular sealed vessel and/or a medicament is removed from the medication tray. The act of removing a sealed vessel and/or a medicament from the medication tray involves passage of the vessel and/or medicament through the cover member, which in turn triggers a detectable electrical response. Suitably, the cover member is configured to trigger a particular electrical response corresponding to the particular portion of the cover member through which a particular vessel and/or medicament passes, thereby enabling identification of the specific vessel and/or medicament removed. As such, the cover member may suitably overlie the vessels so that particular portions of the cover member directly correspond with the positions of particular vessels. In this manner, the dispensation of each vessel and/or medicament can be individually monitored through correlation of a particular electrical response with a particular vessel and/or medication.

The cover member may also serve to releasably retain the sealed vessels and/or medicament within the medication tray. For instance, where said vessels are not releasably retained within the medication tray by any other means (i.e. the vessels will fall out of the tray when held in certain orientations), the cover member may serve a retaining function in addition to the primary detection function. However, the cover member does not in any way serve to seal the vessels.

The cover member suitably comprises a plurality of dispensing portions. Dispensing portions are pre-defined portions of the cover member through which the vessels and/or medicaments are designed to pass through as they are dispensed. As such, the cover member is suitably arranged upon the medication tray so that the dispensing portions overlie (or are aligned with) and thereby correspond with their respective sealed vessels. The dispensing portions are suitably sufficiently large to allow a sealed vessel to pass therethrough.

Non-dispensing portions represent the remainder of the cover member.

Each dispensing portion suitably comprises a sensor. The sensor is typically part of the electrical detection means associated with the cover member. The sensor suitably triggers an electrical response as its corresponding vessel and/or medicament passes through the corresponding dispensing portion.

In an embodiment, each dispensing portion comprises a door operable to open from a closed configuration to allow a corresponding vessel and/or medicament to pass through. The door may be configured to allow opening before the corresponding vessel is dispensed, for instance to provide access to the vessel and/or medicament prior to the removal thereof. Preferably, however, the door is configured to open as the corresponding vessel and/or medicament is forced through the dispensing portion (i.e. the door opens simultaneously with vessel/medicament removal). For instance, the door may be configured to open as the corresponding vessel and/or medicament is forced therethrough (e.g. where pushing upon the bottom of the vessel forces either the vessel or the medication therein to prize open the door and exit the medication tray through the relevant portion of the cover member).

In a particular embodiment, in the closed configuration each door covers its entire dispensing portion so as to leave substantially no gaps in the corresponding portion of the cover member.

In other embodiments, in the closed configuration each door covers only part of the dispensing portion (e.g. to leave a window in the relevant portion of the cover member through which the sealed vessel is visible). However, in such embodiments, each door is suitably of a sufficient size to prevent the corresponding vessel and/or medication being dispensed without the door being opened.

The door suitably comprises one or more breakable connections with the cover member. The door may be defined by perforations within the cover member extending around part or the entire perimeter of the door. In such cases, the door is opened by breaking the breakable connection(s) (e.g. perforations), suitably by force, most suitably under the force of a vessel and/or medicament being forced through the door.

In a particular embodiment, the cover member comprises a plurality of doors (e.g. each defined by breakable perforations within the cover member), wherein the doors are distributed throughout the cover member in a pattern corresponding to the pattern of distribution of the sealed vessels within the medication tray, such that the cover member is/can be associated with the medication tray such that the doors overlie (or are aligned with) their respective vessels to thereby allow said vessels to be removed through said doors.

In preferred embodiments, especially where the door is configured to open under pressure of a vessel and/or medicament being forced out through the cover member, each door is configured to activate a corresponding sensor as the door is opened. As such, an electrical response is suitably triggered as a vessel and/or medicament is forced out through the door.

In a particular embodiment, the cover member comprises a plurality of breakable portions, each located over a respective vessel and configured to break as a respective medicament and/or sealed vessel is removed through the cover member. The electrical detection means is suitably configured to produce an electrical response to the breaking of a breakable portion to enable reporting of the dispensation of a respective medicament and/or vessel.

In preferred embodiments, the cover member is adhered to the tray, preferably so that the overall cover member remains substantially in place as a vessel and/or medicament is dispensed through the cover member. In a particular embodiment, where the medication tray and cover member are integrally formed as a single piece, the cover member is folded back upon the medication tray and adhered thereto, with dispensing portions corresponding to the positions of the respective vessels.

The cover member may comprise or be formed of any suitable material known in the art. The cover member is suitably formed of material that tolerates electric currents in close proximity. For instance, the cover member may be formed of plastics materials or cardboard. In a particular embodiment, the cover member is formed of cardboard. Suitably the cover member comprises two sheets of cardboard and sandwiched between the sheets of cardboard are printed electrically conductive tracks, which suitably connect sensors to a data storage/processing means and a power supply.

A cover member of the invention may be suitably retrofitted to any medication tray, including those already in existence. The dimensions, shape, and arrangement of dispensing portions may be pre-designed around the medication tray intended for its application. The cover member of the invention is particularly well suited to medication trays from which sealed pots are to be dispensed.

### Electrical Detection Means

The detection means is suitably incorporated, at least in part, into a cover member that is adapted to be fitted to the medication tray to form a medication container of the invention as defined herein. Part of the electrical detection means (e.g. sensor(s)) may be incorporated into the cover member whilst part of the electrical detection means is separate from the cover member (e.g. a part of a lid or other portion of the medication container).

The detection means of (or associated with) the cover member serves to automatically detect and/or monitor when a vessel and/or medicament is dispensed from the medication tray during use. As such, there is no need for any manual inputs to record dispensation of a medicament.

Suitably, the detection means comprises sensors associated with (or intended for association with) each sealed vessel of the tray. Suitably, the detection means comprises sensors associated with each dispensing portion of the cover sheet, suitably with each door of the cover sheet. The detection means suitably further comprises data storage and/or processing means where data from the sensors can be stored and/or processed. Suitably, the detection means further comprises electrical connections which connect each sensor to a power supply and a data storage and/or processing means where data from the sensors can be stored and/or processed.

In an embodiment of the invention, the detection means further comprises a transmission means to enable data stored in the data storage and/or processing means to be transmitted and/or downloaded, optionally for further analysis and processing.

The detection means may further comprise a user interface to enable an operator to input additional data which can be stored on the storage/processing means and optionally correlated with data from the sensors.

The detection means may further comprise a visual display to display information to the user.

Any suitable sensor capable of detecting when the vessel present in any given compartment is released may be used in the medication container of the present invention.

The sensor may comprise electrical contacts which connect to form an electrically conductive circuit (and thereby generate an electrical signal) when an operator applies a pressure to dispense the vessel releasably retained therein.

Alternatively, the sensor may comprise an electrically conductive circuit or track which is broken when an operator applies a pressure to release a vessel from the tray or when an operator breaches a dispensing portion in releasing a vessel from the tray. The breakage of the circuit can be detected and recorded. For instance, an electrically conductive track may be configured traverse a dispensing portion and non-dispensing portion of the cover member such that the track is broken when a sealed vessel and/or medicament passes through the dispensing portion. In a particular example, an electrically conductive track traverses a door of the cover member such wise that the track breaks as the door is opened, to thereby trigger an electrical response.

The data storage/processing means may be any suitable electronic data storage and/or processing device such as, for example, a microchip or module, which can be conveniently incorporated into the medication tray. Suitable microchips and modules are commercially available and can be programmed with appropriate software to provide the functionality that is required.

The data storage/processing means is preferably configured to receive electrical signals from the sensors associated with each individual compartment. Furthermore, the data storage and/or processing means may be pre-programmed to monitor the response from each sensor over time. For example, when a sensor is activated by an operator dispensing a vessel and/or medication from a particular compartment (or part of the medication tray), that event can be recorded and coupled with appropriate date/time data.

In addition, the data storage and/or processing means may be pre-programmed to detect whether a particular sensor associated with a particular compartment is activated within a predetermined time frame. This enables the detection means to monitor whether the correct medication is being taken at the appropriate time. In addition, if the medication has not been dispensed at the required time, the detection means can either record the event or, optionally, it may trigger an alert, such as an alarm, flashing light or LED, or a message sent via the transmission means, to draw attention to the missed dose of medication.

The data storage and/or processing means may be further configured to receive manual data inputs from a user interface, where an operator can input additional data by pressing one or more buttons on the user interface. The pressing of a particular button may be correlated with other data from the sensors and stored by the storage/processing means.

The user interface is suitably provided on a surface of the container or the detection means.

The power supply may be a battery which provides a low voltage power supply to the sensors and the storage/processing means.

The transmission means may be any suitable means for transmitting data from the storage/processing means. For example, the transmission means may be a data transfer port that can be connected to an external computer to enable the data from the data storage and/or processing means to be downloaded. Alternatively, the transmission means may be a transmitter which can transmit data wirelessly to a receiver. For example, the tray may be configured to wirelessly connect to the internet to transmit data on-line. A further alternative is that the data can be accessed by scanning the tray.

Suitably, the transmission means uses RFID, NFC, Bluetooth or WIFI to transmit the data. In a particular embodiment, the transmission means is a short range transmitter that utilises RFID data transmission.

The data processing means may further comprise an alerting means, such as an alarm or flashing light/LED, which can be activated if, for example, a vessel present in a particular compartment has not been dispensed at the correct time, or if a vessel has been dispensed from a compartment at an incorrect time.

Suitably the data storage/processing means, power supply, and the transmission means may be provided in a single module, such as, for example, the Cypak Electronic Module (CEM083), Cypak AB, Sweden.

Suitably the cover member comprises a plurality of sensors arranged within the cover member so that they align with the top of each vessel of the tray, and wherein the sensors are adapted to detect when a sealed vessel and/or medicament is forced through the cover member.

As previously indicated, the sensor may be in the form of a switch which is activated when an operator forces a vessel and/or medicament through the cover member. Alternatively, the cover member may comprise doors that are configured to be opened ro dislodged (or “broken away”) from the remainder of the cover member when a pressure is applied, each door being aligned with a respective vessel and provided with an electrically conductive circuit or track which is broken when said door is opened or dislodged. Suitably, said doors are surrounded by perforations to facilitate their opening or dislodgement from the remainder of the cover member.

The cover member will suitably further comprise the data storage and/or processing means, power supply and transmission means as defined hereinbefore. Suitably, the cover member also comprises a user interface.

The base of the medication tray may be made from any suitable material that can be deformed by an operator to enable the contents of the medication tray to be dispensed.

The systems of the present invention provide an automated means by which patient compliance can be monitored. Data regarding whether or not medication has been taken at the correct time can be collected and stored on the data storage and/or processing means. These data can be monitored periodically, for example at the end of a particular period of treatment covered by the medication system, or at intervals during the treatment period. In a particular embodiment, data can be monitored in real time, if desired.

The individual that can access the data could be a pharmacist, doctor, nurse, a carer, or the patient.

The detection means may be further configured to store data about the identity of the person accessing the data and the date/time that the data was accessed. This enables the detection means to also record how often the patient is being monitored.

In a particular scenario, the patient or carer could return the container to a doctors surgery or a pharmacy at the end of the treatment period and the data stored in the storage/processing means can be downloaded and the compliance of the patient with the prescribed therapy can be assessed.

In a further scenario, a health visitor, such as doctor or nurse, can access the information from the tray when they visit the patient.

In a yet another scenario, the data can be accessed remotely, for example via the internet, to enable remote monitoring of patient compliance. In yet another alternative, data can be sent to a mobile device, such as, for example, a mobile phone.

The data storage and/or processing means can also be programmed to perform additional functions, such as, for example:
detecting when medication has not been taken and raising an alarm;
detecting when too much medication has been accessed, e.g. where a number of vessels and/or medicaments are dispensed and there is the potential danger of over dose;
correlating the dispensing of a medicament from the tray with other medical interventions or assessments, such as issuing alerts to take a blood pressure reading, blood sample etc.
re-ordering a patients' medication automatically by transmitting a message when the medication present in the tray has run out or is getting close to running out.

A key advantage associated with the provision of a detection means that is separate from the medication tray is that can be fitted to a medication tray at the point of dispensing. The pharmacist can then decide whether the detection means/cover member is required with the medicament tray for any given patient.

According to a further aspect of the invention, there is provided a system comprising a medication container as defined herein in combination with a computer for storing data and a printer for printing an information sheet displaying information relating to the medicaments packaged in the medication container and a device adapted to automatically apply a printed sheet to the medication container.

The system may also include software to display on a computer screen an image of a container as aforesaid and to enable an image representative of a substance to be packaged to be displayed on or adjacent an image of an individual vessel within the container.

The software may display the substance by drag and drop from a list of substances in text form displayed alongside the container image on the screen.

The software may be adapted to convert the display of an image of the substance on the screen into text to be printed on the sheet.

The software may be adapted to produce an image on the screen of a set of data representative of the intended use of the substances to be packaged, such as a date by which a packaged substance should be used.

The system may include an outer container for transportation, adapted to receive a plurality of the aforesaid containers in superimposed relationship with spaced dividing members whereby the aforesaid containers may be housed within the outer container in the manner of drawers.

Method of Producing a Medication Container

According to a further aspect of the present invention, there is provided a method of producing a medication container as defined herein, the method comprising:

associating the cover member, as defined herein, with a medication tray, as defined herein;

configuring the cover member relative to the medication tray such that the cover member permits dispensing of medicaments and/or vessels therethrough.

Suitably, the medication tray is assembled by dispensing sealed vessels from a primary medication container (e.g. a monitored dosing systems intended to remain in a care home), and placing said sealed vessels within the medication tray before a cover member is placed upon the sealed vessels ready to monitor dispensation of the sealed vessels. However, the sealed vessels are suitably formed by applying a sealing means to the vessels once medicament has been placed thereinto.

Configuring the cover member suitably involves aligning dispensing portions of the cover member with the sealed vessels within the medication tray, so that the sealed vessels can be dispensed through said dispensing portions. Preferably the cover member is adhered to the medication tray.

In a particular embodiment, a single cardboard sheet comprising both the cover member and medication tray (or the carrier tray thereof) in the same sheet, is first loaded with sealed vessels before the cover member is folded to cover the sealed vessels, and suitably fixed so that the cover member retains the vessels in place. Optionally, the single cardboard sheet additionally comprises a lid, said lid may also be folded to cover the cover member.

### Kit of Parts

According to a further aspect of the present invention, there is provided a kit of parts comprising a medication tray (or carrier tray) configured for receiving a plurality of sealed vessels, and the cover member as defined herein. The medication tray, in this context, does not necessarily contain any sealed vessels, since these may be provided separate from the kit.

However, in an embodiment, the kit of parts comprises a plurality of medicament-containing sealed vessels which, when required, may be placed within the medication tray.

In an alternative embodiment, the kit of parts comprises a plurality of vessels and a sealing means for sealing said vessels to form sealed vessels. Clearly, the medicament is usually provided at the time the kit of parts is assembled into a medication container of the present invention.

In a particular embodiment, the medication tray (or carrier tray) and the cover member may be provided together as a “blank”, as defined herein.

### Blank for Manufacturing a Medication Tray

According to a further aspect of the present invention, there is provided a blank for manufacturing a medication container, the blank comprising:

a carrier tray configured for receiving a plurality of sealed vessels;

a cover member, as defined herein, connected to the carrier tray at a first fold line;

wherein the cover member is foldable about the first fold line to cover the carrier tray so as to permit the dispensing of medicaments and/or vessels from the carrier tray through the cover member.

The blank is typically formed of a foldable material, which is suitably rigid. In a particular embodiment, the blank is formed of cardboard.

The first fold line is suitably strategically located so that the cover member can be folded over the carrier tray so that dispensing portions (or doors) of the cover member suitably align with the intended position of the sealed vessels within the carrier tray.

As described herein, the cover member is suitably at least two-ply to allow electrical circuitry (e.g. electrical tracks) to be disposed in between the at least two-plies within the cover member. As such, the carrier tray may also be at least two-ply.

In an embodiment, the blank additionally comprises a lid, connected to either the carrier tray or the cover member via a second fold line. The lid is suitably foldable about the second fold line to cover the cover member.

In a particular embodiment, the blank comprises a carrier tray connected to a cover member at a first fold line, and a lid connected to the cover member at a second fold line. Suitably the carrier tray has a plurality of apertures for receiving the sealed vessels, and the cover member has a plurality of doors which align with said apertures of the carrier tray when the cover is folded over the carrier tray.

### Method of Dispensing Medication

According to a fifth aspect of the present invention, there is provided a method of dispensing medication, the method comprising:

providing a medication container, as defined herein;

removing a medicament and/or a medicament-containing vessel from the medication container, out through the cover member to thereby automatically trigger an electrical response in the electrical detection means.

In a particular embodiment, where the cover member comprises a series of doors (i.e. through which the vessels may exit), a sealed vessel is dispensed by forcing the sealed vessel upwards through the door to thereby open said door and consequently trigger an electrical response.

Preferably, vessels are dispensed from the medication container such that the remain sealed after dispensation. As such, the vessel is suitably then opened/unsealed by the patient before the medicament contained therein is administered.

### Example Embodiments

The exemplary embodiments of the present invention will be discussed in detail in relation to medication container which provides both portability and effective automated monitoring of medicament dispensation. Such medication containers allow, for example, an elderly resident of a care home to leave home to visit relatives and friends carrying medication whose dispensation can still be monitored by the care home. However, the teachings, principles and techniques of the present invention are also applicable in other exemplary embodiments. For example, the cover member of the present invention may be retrofitted to standard blister packs to allow for effective medicament dispensation monitoring, or alternatively retrofitted to prefabricated medication containers, such as the monitored dosing systems of WO 2009/047560.

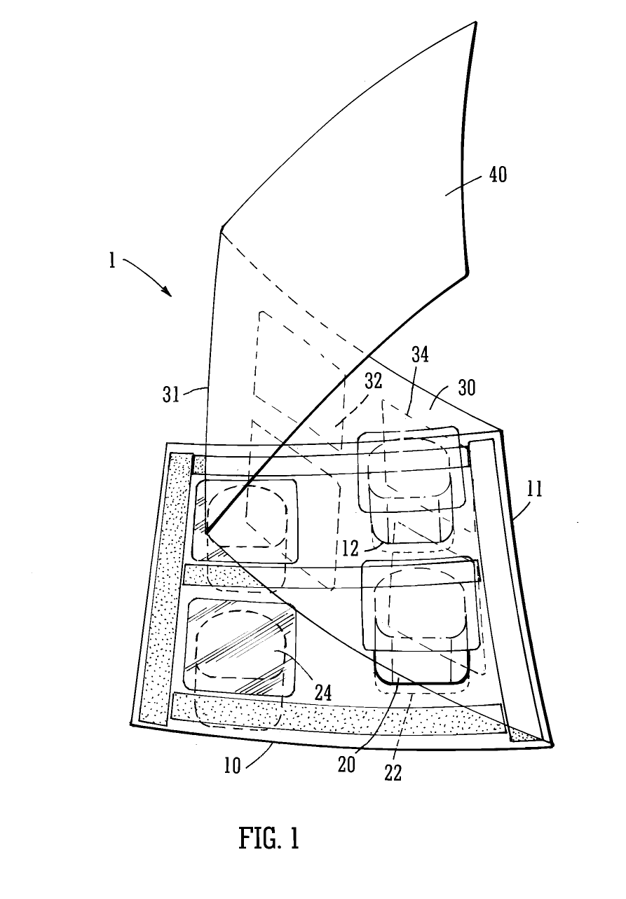

FIG. 1 is top perspective view of a partially unfolded portable medication container 1 with a carrier tray 10 containing four sealed pots 20, a cover member 30 covering the pots 20, and a lid 40 covering the cover member 30.

The carrier tray 10, cover member 30, and lid 40 are all integrally formed from a single piece of cardboard. The cover member 30 is linked to the carrier tray 10 via a first fold line 11, and the lid 40 is linked to the cover member 30 via a second fold line 31, such that the cover member 30 is folded over the carrier tray 10 and the sealed pots 20 contained therein, and the lid 40 is folded over the cover member 30.

The carrier member 10 has four holes 12, each complementary in size and shape to the sealed pots 20 which fit thereinto. Each sealed pot 20 has a pot 22 with a flanged rim around the mouth thereof to which a seal 24 is fitted. Each seal 24 is an individual flexible liquid impermeable film 24 that is heat sealed around the flange of each pot 22 to produce a sealed pot 20. Each sealed pot 20 contains a medicament—in this particular example a liquid dosage form.

Each sealed pot 20 sits within a respective hole 12 of the carrier tray 10 with the base of the pot 22 exposed and protruding beneath the carrier tray 10 whilst the flanged rim is supported by the carrier tray 10 around the respective hole 12. In the finished ready-to-use article, the cover member 30 is folded over and adhered to the carrier tray 10 in a closed position so that the cover member 30 does not unfold about the respective fold line 11.

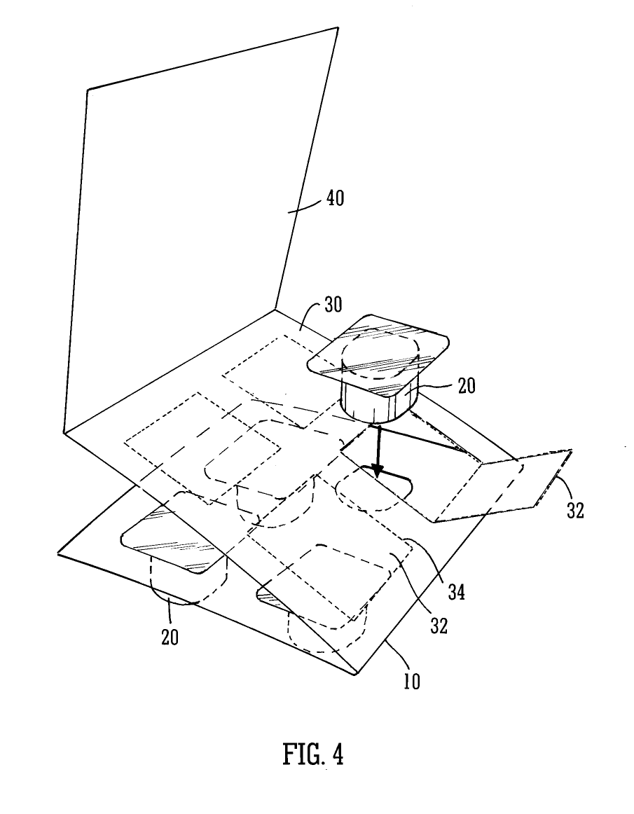

The cover member 30 has a series of doors 32 defined about their periphery by breakable perforations 34. When the cover member 30 is fixed down over the carrier tray 10 (as per FIG. 4), the doors 32 overlie and are in substantial alignment with the location of the sealed pots 20 within the carrier tray 10. As such, each door 32 serves a particular sealed pot 20. As will become apparent, this allows each sealed pot 20 to be dispensed from the carrier tray 10 through pushing the pot 22 upwards from its base to force it through its respective door 32 as the perforations 34 break under the applied force.

Finally, the lid 40 is arranged to close over the cover member 30 to mitigate against accidental damage to the doors 32 and/or perforations 34 thereof. However, the lid 40 is not fixed to the cover member 30, and instead freely pivots relative thereto about the respective fold line 31 to allow the lid 40 to be opened to expose the cover member 30 and thereby allow sealed pots 20 to be removed. As such, the fold line 31 serves as a hinge.

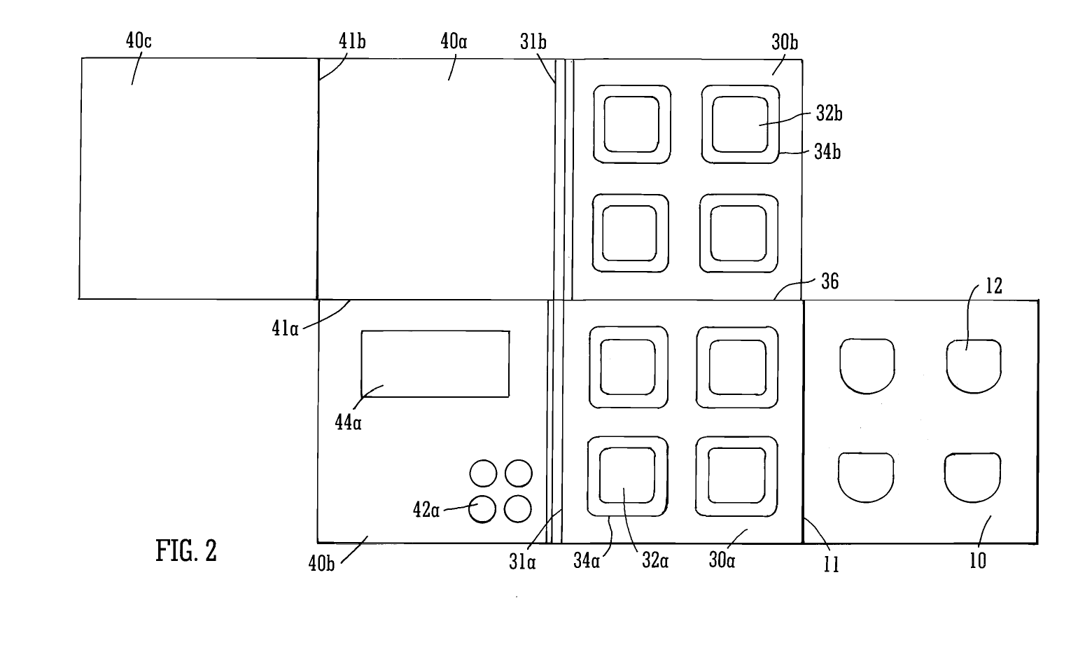

FIG. 2 is a top view of a “blank” of the medication container of FIG. 1 (without sealed pots). The blank is composed of a single piece of cardboard which is foldable into a medication container suitable for receiving the sealed pots 20. In particular, the blank consists of the carrier tray 10; top 30a and bottom 30b cover layers (or plies) which together make up a two-ply cover member 30; and top 40a, middle 40b, and bottom 40c lid layers (or plies) which together make up a three-ply lid 40, though in use the bottom lid layer 40c can be opened to reveal the inner middle layer 40b. Here the terms “top” and “bottom” relate to the position of the respective layers in the finished medication container 1 (i.e. after the blank has been folded) based on the carrier tray 10 being at the bottom. The carrier tray 10 is joined to the first cover layer 30a via the first fold line 11. The two cover layers 30a, 30b are joined together at a fold line 36, and each cover layer 30a, 30b, is itself joined to neighbouring lid layers 40a, 40b at respective fold lines 31a, 31b. Lid layers 40a, 40b, 40c are joined together in an “L”-shaped configuration at respective fold lines 41a, 41b.

As per the completed medication container 1 (corresponding to the “folded” blank), the carrier tray 10 has holes 12; and the cover member 30 has matching doors 32a, 32b defined by perforations 34a, 34b in each of the respective top and bottom cover layers 30a, 30b. Furthermore, the blank of FIG. 2 shows additional features of the lid 40, in which the middle lid layer 40b has a user interface 42a (with manually operable buttons) and also a graphics screen 44a (capable of displaying information). As mentioned above, in use the middle lid layer 40b is accessible by opening the bottom lid layer 40c about fold line 41b.

Though the blanks may be produced in a number of ways, so as to be foldable in a number of ways, FIG. 2 in fact indicates how the blank of this particular example should be folded to produce the medication container (without sealed pots) in view of the text labels. The text labels may, in practice, provide instructions and/or relate to the particular medicaments contained within the sealed pots 20. The blank of FIG. 2 is intended to be folded into a medication container 1 such that the text is readable in the direction indicated. Readable text is present on certain visible surfaces of the blank of FIG. 2, particularly the visible surfaces of the carrier tray 10, the top cover layer 30a, the top lid layer 40a and bottom lid layer 40c. The visible surface of the carrier tray 10 becomes the bottom surface of the medication container 1 out of which the sealed pots 20 protrude. The visible surface of the top cover layer 30a becomes the top of the cover member 30 out of which sealed pots emerge when dispensed. The visible surface of the top lid layer 40a becomes the top of the lid 40 of the closed medication container 1. The bottom lid layer 40c becomes the bottom of the lid which, when closed, faces inwards towards the top of the cover member 30. As such, upon folding the blank into the medication container, the middle lid layer 40b becomes sandwiched between the top and bottom lid layers 40a, 40c, and the visible surface of the middle lid layer 40b (which consists of the graphics screen and user interface) is revealed by opening the lid 40 and then unfolding the bottom lid layer 40c about fold line 41b. As such, the graphics screen 44a and user interface 42a are protected by the bottom lid layer 40c in the closed position.

The blank of FIG. 2 is folded into a medication container 1 by first folding along the fold line collectively defined by both fold lines 36 and 41a so as to fold the invisible surfaces inwards towards each other (i.e. folding the surfaces visible in FIG. 2 away from each other) so that visible surfaces of the top cover layer 30a and middle lid layer 40b face upwards. The internal surfaces of each are adhered together so that they are permanently stuck together. Carrier tray 10 is then folded underneath the cover member 30 so that the surface of the carrier tray 10 originally visible in FIG. 2 faces downwards and is at the bottom of the container 1. The bottom lid layer 40c is then folded inwards to sandwich the middle lid layer 40b between the bottom and top lid layers, and the entire 3-ply lid 40 is then closed upon the top cover layer 30a to form a book such as that shown in FIG. 1. The medication container 1 is completed by inserting medicament-containing sealed pots 20 into the respective holes 12 of the carrier tray 10, before covering the tops of the sealed pots with cover member 30 and adhering the cover member 30 to the carrier tray 10.

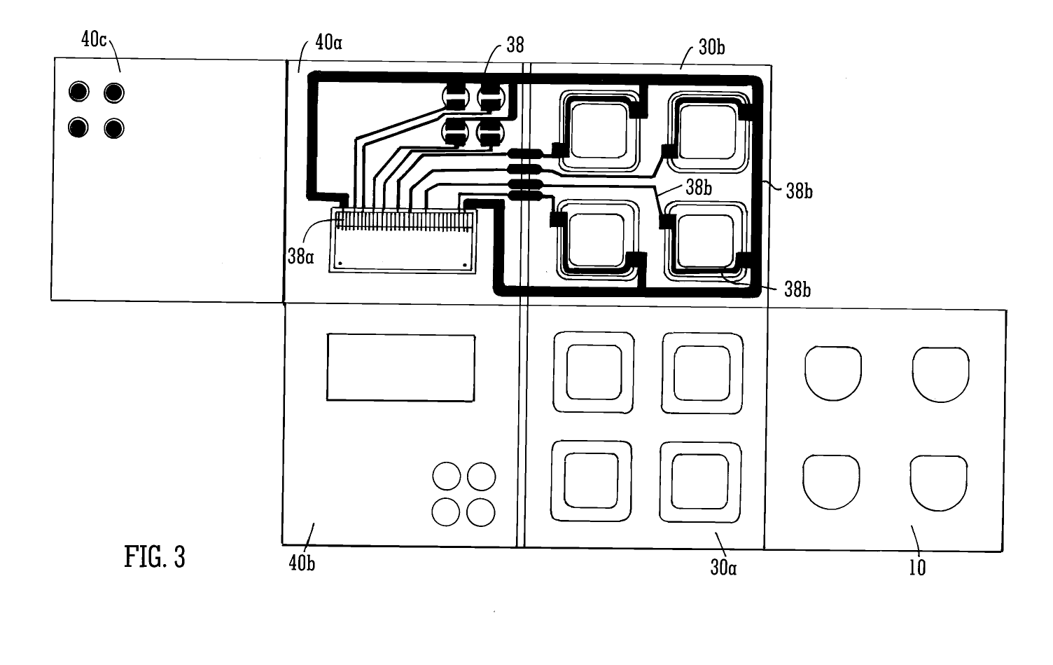

FIG. 3 is another top view of the “blank” of FIG. 2, this time showing electrical circuitry and components underlying the visible surface of the blank shown (i.e. the visible surfaces of the bottom cover layer 30b, top lid layer 40a, and bottom lid layer 40c of FIG. 3 are represented as transparent so that the electrical circuitry beneath is visible). It will be apparent that when the blank is folded into the medication container 1, the electrical circuitry becomes sandwiched between the respective cover layers and lid layers so as to become invisible. As such, the electrical circuitry and components resides on “invisible” surfaces of the ultimate medication container 1.

The electrical circuitry and components collectively constitute an electrical detection means 38 which operates in the medication container 1 to monitor dispensation of the sealed pots 20. As depicted in FIG. 3, the electrical detection means extends across the “invisible” surfaces of both the bottom cover layer 30b and top lid layer 40a.

The electrical detection means includes a module 38a (e.g. Cypak Electronic Module (CEM083) Cypak, Sweden) having an integrated power supply, data storage and/or processing means, and transmission means, but also includes a plurality of electrically conductive ink tracks 38b. Each of the four doors 32b on the bottom cover layer 30b are traversed by a separate electrically conductive track 38b which is connected to a separate port of the electronic module. The module provides a low level electrical current across each of the perforations 34b of the underside of the bottom cover layer 30b.

FIG. 4 is a top perspective view of the medication container of FIG. 1, showing the removal of a sealed vessel. Referring both to FIGS. 3 and 4, during use, an operator wishing to release a sealed pot 20 from the carrier tray 10 applies an upward pressure underneath of the sealed pot 20 to force the sealed pot first through the respective door 32b of the bottom cover layer 30b and then through the respective door 32a of the top cover layer 30a, to which the bottom cover layer 30b is adhered, until the pot is finally dispensed from the container. The upward pressure upon the sealed pot 20 causes the perforations 34b, a around the respective doors 32b, 32a to break so as to ultimately release the sealed pot 20 through the cover member 30. As the perforations 34b of the bottom cover layer 30b break, the associated printed electrically conductive track also breaks. The breaking of the circuit is detected and recorded by the module 38a and is correlated with the date and time that the medicament in the corresponding sealed pot 20 is dispensed. The data recorded by the module can be downloaded when desired via a RFID transmitter.

1. A medication container, comprising:
a medication tray comprising a plurality of sealed vessels, each containing a medicament;
a cover member covering the sealed vessels and adapted to permit dispensing of individual medicaments and/or vessels therethrough,
wherein the cover member is associated with an electrical detection means configured to automatically produce an electrical response to a medicament and/or vessel being dispensed through the cover member.

2. (canceled)

3. The medication container of claim 1, wherein the cover member includes the electrical detection means or part of the electrical detection means.

4. The medication container of claim 1, wherein the cover member serves to releasably retain the sealed vessels and/or medicament within the medication tray.

5. The medication container of claim 1, wherein the cover member does not seal the vessels.

6. The medication container of claim 1, wherein the cover member comprises a plurality of dispensing portions, wherein the dispensing portions are pre-defined portions of the cover member through which the vessels and/or medicaments are designed to pass through as they are dispensed.

7. The medication container of claim 6, wherein, each dispensing portion comprises a sensor, wherein each sensor is part of the electrical detection means associated with the cover member, and wherein each sensor triggers an electrical response as its corresponding vessel and/or medicament passes through the corresponding dispensing portion.

8. The medication container of claim 7, wherein each dispensing portion comprises a door operable to open from a closed configuration to allow a corresponding vessel and/or medicament to pass through.

9. The medication container of claim 8, wherein the door is configured to open as the corresponding vessel and/or medicament is forced through the dispensing portion

10. The medication container of claim 8, wherein the door comprises one or more breakable connections with the cover member.

11. The medication container of claim 10, wherein the door is defined by perforations within the cover member extending around part or the entire perimeter of the door.

12. The medication container of claim 8, wherein each door is configured to activate a corresponding sensor as the door is opened

13. The medication container of claim 6, wherein the medication tray and cover member are integrally formed as a single piece, and the cover member is folded back upon the medication tray and adhered thereto, with dispensing portions corresponding to the positions of the respective vessels.

14. (canceled)

15. The medication container of claim 13, wherein the cover member comprises two sheets of cardboard and sandwiched between the sheets of cardboard are printed electrically conductive tracks, which suitably connect sensors to a data storage/processing means and a power supply.

16. The medication container of claim 15, wherein the detection means of (or associated with) the cover member serves to automatically detect and/or monitor when a vessel and/or medicament is dispensed from the medication tray during use.

17. (canceled)

18. The medication container of claim 16, wherein the detection means comprises data storage and/or processing means where data from the sensors can be stored and/or processed.

19. The medication container of claim 18, wherein the detection means further comprises a transmission means to enable data stored in the data storage and/or processing means to be transmitted and/or downloaded.

20. The medication container of claim 19, wherein the sensor comprises an electrically conductive circuit or track which is broken when an operator applies a pressure to release a vessel from the tray or when an operator breaches a dispensing portion in releasing a vessel from the tray.

21-23. (canceled)

24. The medication container claim 1, wherein the medication tray comprises:
a carrier tray having a plurality of individual spaced compartments (or apertures); and
a plurality of medicament-containing sealed vessels individually removably received within the respective compartments (or apertures).

25. The medication container claim 1, wherein vessels are removable from the tray through applying an upwards force to the bottom of the respective vessel to push the vessel out through the cover member.

26. The medication container claim 1, wherein the sealed vessels are individual flanged pots.

27. A cover member for covering a plurality of medicament-containing sealed vessels of a medication tray, the cover member being adapted to permit dispensing of medicaments and/or vessels therethrough, and associated with an electrical detection means capable of automatically producing an electrical response to a medicament and/or vessel being dispensed through the cover member.

28. A blank for manufacturing a medication container, the blank comprising:
a carrier tray configured for receiving a plurality of sealed vessels;
a cover member adapted to permit dispensing of medicaments and/or vessels therethrough, and associated with an electrical detection means capable of automatically producing an electrical response to a medicament and/or vessel being dispensed through the cover member and connected to the carrier tray at a first fold line;
wherein the cover member is foldable about the first fold line to cover the carrier tray so as to permit the dispensing of medicaments and/or vessels from the carrier tray through the cover member.

29. The blank of claim 28, wherein the first fold line is suitably strategically located so that the cover member can be folded over the carrier tray so that dispensing portions (or doors) of the cover member, through which medicaments and/or vessels can be dispensed therethrough, align with the intended position of the sealed vessels within the carrier tray.

30. The blank of claim 29, wherein the blank additionally comprises a lid, connected to either the carrier tray or the cover member via a second fold line

31. The blank of claim 30, wherein the blank comprises a carrier tray connected to a cover member at a first fold line, and a lid connected to the cover member at a second fold line, and wherein the carrier tray has a plurality of apertures for receiving the sealed vessels, and the cover member has a plurality of doors which align with said apertures of the carrier tray when the cover is folded over the carrier tray.

32-34. (canceled)
